(19) United States
(12) Patent Application Publication
(10) Pub. No.: US 2014/0246935 A1
(43) Pub. Date: Sep. 4, 2014

(54) HYBRID DRIVE APPARATUS

(71) Applicant: AISIN AW CO., LTD., Anjo-shi, Aichi-ken (JP)

(72) Inventors: Satoru Kasuya, Nishio (JP); Masashi Kito, Anjo (JP); Yuichi Seki, Okazaki (JP); Yusuke Takahashi, Anjo (JP)

(21) Appl. No.: 14/342,195

(22) PCT Filed: Dec. 26, 2012
(86) PCT No.: PCT/JP2012/083669

§ 371 Date: Feb. 28, 2014

(30) Foreign Application Priority Data
Dec. 26, 2011 (JP) 2011-283118

(51) Int. Cl. H02K 7/116; H02K 7/108

(52) U.S. Cl. CPC H02K 7/116; H02K 7/108
USPC 310/78; 310/83

(57) ABSTRACT

A hybrid drive apparatus, which includes a speed change mechanism disposed on a first axis coaxial with an engine output shaft and a rotary electric machine disposed on a second axis parallel to the first axis, including: a case main body which accommodates the speed change mechanism and the rotary electric machine and has an opening portion opening on one side of the speed change mechanism in an axial direction; and a cover member which closes the opening portion of the case main body, wherein the rotary electric machine is disposed such that a portion thereof overlaps the cover member when viewed in the axial direction.

### TECHNICAL FIELD

The present invention relates to a hybrid drive apparatus which is mounted on a vehicle such as an automobile, and more particularly, relates to a hybrid drive apparatus including a rotary electric machine which is disposed on an axis different from the axis of a speed change mechanism.

### BACKGROUND ART

In recent years, various hybrid drive apparatuses have been developed due to environmental problems or the like, and as a method which simply structures the hybrid drive apparatus at a low cost, a method that a motor-generator (hereinafter, simply referred to as a “motor”) is mounted on an automatic transmission to be hybridized, is considered.

When the motor is mounted on the automatic transmission, a structure in which the motor is disposed on the outer peripheral side of a starting device (torque convertor or starting clutch) or a structure in which the motor is disposed between the starting device and the speed change mechanism in an axial direction is considered. However, since the motor is mounted, an axial length of the hybrid drive apparatus is increased. Thus, as in an FF type (front engine-front drive) vehicle, in particular, if it is considered that the axial length of the hybrid drive apparatus influences a vehicle width, a steering angle, or the like, reduction in the axial length of the hybrid drive apparatus is required. Accordingly, it is suggested that the axial length of the hybrid drive apparatus is reduced by disposing the motor on a separate axis which is parallel to the speed change mechanism (causing a motor axis and an axis of the speed change mechanism to be different from each other) (for example, refer to Patent Document 1).

### RELATED ART DOCUMENT

### Patent Document

[Patent Document 1] Japanese Patent Application Publication No. 2009-101729 (JP 2009-101729 A)

### SUMMARY OF THE INVENTION

### Problem to be Solved by the Invention

Like Patent Document 1, disposing the motor on the axis different from the axis of the speed change mechanism makes the reduction in length in the axial direction possible. However, since the motor is disposed, there is a problem that the hybrid drive apparatus is accordingly enlarged in a radial direction.

Therefore, an object of the present invention is to provide a hybrid drive apparatus which includes a rotary electric machine disposed on a second axis parallel to a first axis on which a speed change mechanism is disposed and is capable of downsizing in a radial direction.

### Means for Solving the Problem

According to the present invention (for example, refer to FIGS. 1 to 3), there is provided a hybrid drive apparatus (1), which includes a speed change mechanism (30) disposed on a first axis (AX1) coaxial with an engine output shaft (2) and a rotary electric machine (40) disposed on a second axis (AX2) parallel to the first axis (AX1), characterized by including: a case main body (4B) which accommodates the speed change mechanism (30) and the rotary electric machine (40) and has an opening portion (4Bc) opening on one side of the speed change mechanism (30) in an axial direction; and a cover member (4C) which closes the opening portion (4Bc) of the case main body (4B)), in which the rotary electric machine (40) is disposed such that a portion thereof overlaps the cover member (4C) when viewed in the axial direction.

Thus, since the rotary electric machine disposed on the second axis parallel to the first axis on which the speed change mechanism is disposed is disposed such that a portion thereof overlaps the cover member, which covers one side of the speed change mechanism in the axial direction, when viewed in the axial direction, the rotary electric machine and the speed change mechanism can be disposed close to each other, and thus, downsizing of the hybrid drive apparatus in the radial direction can be achieved.

Moreover, the present invention (for example, refer to FIGS. 1 and 2) is characterized in that the rotary electric machine (40) includes a stator (41) which is fixed to the case main body (4B) and a rotor (42) which is rotatably disposed on an inner peripheral side of the stator (41), and the stator (41) is disposed such that a portion thereof overlaps the cover member (4C) when viewed in the axial direction.

Thus, since the stator is disposed such that a portion thereof overlaps the cover member when viewed in the axial direction, the stator can be disposed close to the speed change mechanism, and downsizing of the hybrid drive apparatus in the radial direction can be achieved.

In addition, the present invention (refer to FIG. 1) is characterized in that a connection mechanism (20), with which the speed change mechanism (30) and the rotary electric machine (40) are drivingly connected, is provided on a side more toward an engine in the axial direction than the speed change mechanism (30), and the rotary electric machine (40) is disposed so as to overlap the speed change mechanism (30) when viewed in a radial direction.

Thus, since the rotary electric machine is disposed so as to overlap the speed change mechanism when viewed in the radial direction, an axial length of the hybrid drive apparatus can be reduced while downsizing of the hybrid drive apparatus in the radial direction can be achieved.

Moreover, the present invention (for example, refer to FIG. 1) is characterized in that the speed change mechanism (30) includes a plurality of friction engagement elements (C-1, C-2, C-3, B-1, B-2, and B-3), and a plurality of shift speeds are achieved by engagement and disengagement of the friction engagement elements, a friction engagement element (B-1) having a largest outer diameter, among the plurality of friction engagement elements, is disposed at an end portion on a side of the speed change mechanism (30) opposite from the engine in the axial direction, and a joint portion (4J) which joins the case main body (4B) and the cover member (4C) is disposed on an outer peripheral side of the friction engagement element (B-1) having the largest outer diameter.

Thus, the joint portion which joins the case main body and the cover member is disposed on an outer peripheral side of the friction engagement element having the largest outer diameter, that is, the outer diameter of the cover member protrudes in the radial direction, but the outer diameter of the speed change mechanism is recessed to the inner diameter side from the cover member on the side more toward the engine than the friction engagement element having the largest outer diameter. Therefore, the rotary electric machine can be disposed close to the speed change mechanism by disposing the rotary electric machine at the recessed portion, and downsizing of the hybrid drive apparatus in the radial direction can be achieved.

In addition, the present invention (for example, refer to FIG. 1) is characterized in that at least a portion of the speed change mechanism (30) is assembled to the case main body (4B) from a side opposite from the engine in the axial direction via the opening portion (4Bc), and the rotary electric machine (40) is assembled to the case main body (4B) from the engine side in the axial direction.

Thus, since at least a portion of the speed change mechanism is assembled to the case main body from a side opposite from the engine in the axial direction, and the rotary electric machine is assembled to the case main body from the engine side in the axial direction, the rotary electric machine can be disposed such that a portion thereof overlaps the cover member when viewed in the axial direction, the rotary electric machine and the speed change mechanism can be disposed close to each other, and thus, downsizing of the hybrid drive apparatus in the radial direction can be achieved.

Note that the reference numerals in parentheses are provided for reference to the drawings and for convenience of understanding of the present invention, and thus, the reference numerals do not influence the structures of claims at all.

### BRIEF DESCRIPTION OF THE DRAWINGS

FIG. 1 is a partially omitted sectional view showing a hybrid drive apparatus.

FIG. 2 is a schematic side view of the hybrid drive apparatus.

FIG. 3 is an engagement table of a speed change mechanism.

### MODES FOR CARRYING OUT THE INVENTION

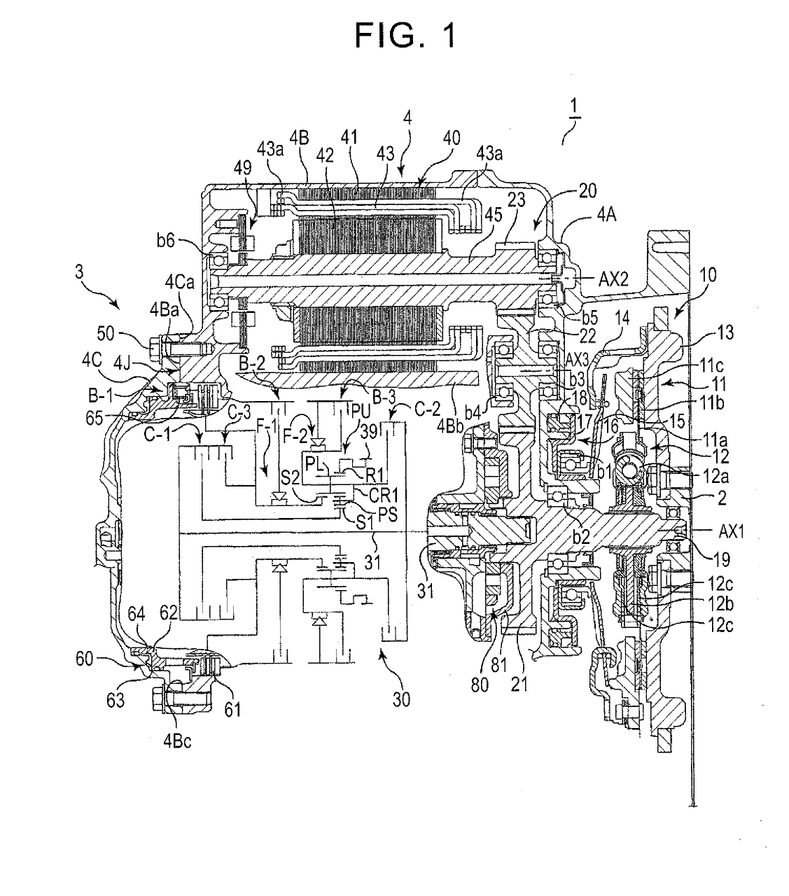

Hereinafter, a hybrid drive apparatus 1 to which the present invention is applied will be described with reference to the drawings. As shown in FIG. 1, the hybrid drive apparatus 1 is suitably mounted on an FF type vehicle, a clutch device 10 and a speed change mechanism 30 of an automatic transmission 3 are disposed on a first axis AX1 which is coaxial to an engine output shaft (crankshaft) 2, and a motor (rotary electric machine) 40 is disposed on a second axis AX2 which is parallel to and is different from the first axis AX1.

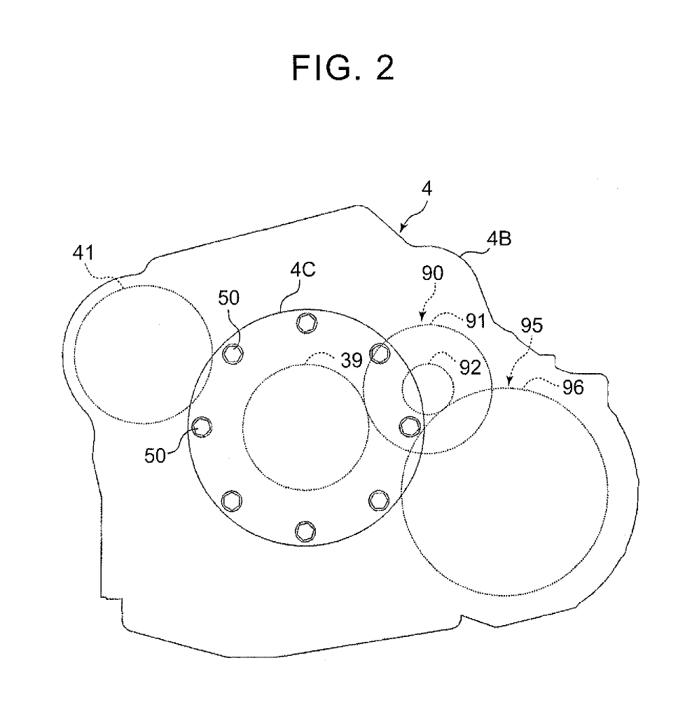

As shown in FIG. 2, a counter shaft 90 which includes a counter driven gear 91 meshing with a counter drive gear 39 described below and a drive pinion 92, and a differential device 95 which includes a differential ring gear 96 meshing with the drive pinion 92 are disposed on an axis different from the first axis AX1 and the second axis AX2.

As shown in FIG. 1, a case 4 includes a housing case 4A which accommodates the clutch device 10 and a connection mechanism 20 described below, a main case (case main body) 4B which accommodates the motor 40, the speed change mechanism 30, the counter shaft 90, and the differential device (refer to FIG. 2), and a rear cover (cover member) 4C which closes an opening portion 4Bc of the main case 4B, and the case 4 is a three-divided structure in which the cases are integrally fixed. In a use state of the case 4, a front end surface of the housing case 4A is integrally fixed to an engine (not shown).

The clutch device 10 disposed in the housing case 4A includes a flywheel 13 which is connected to the engine output shaft 2, a clutch 11, a damper 12, and a hydraulic servo 16 which engages and disengages the clutch 11, and these are disposed on an outer peripheral side of an intermediate shaft 19 to structure the clutch device 10.

The clutch 11 includes a clutch facing 11b and a pressure plate 11c which are disposed to sandwich a cushion plate 11a, and the clutch facing 11b is integrally joined the flywheel 13. The pressure plate 11e is biased to contact the cushion plate 11a by a spring between a clutch cover 14 mounted on the flywheel 13 and the pressure plate 11c, and a diaphragm spring 15 is supported on the clutch cover 14 with a radial intermediate portion of the diaphragm spring 15 as a supporting point.

Meanwhile, the damper 12 is spline-engaged with an outer peripheral portion of the engine side of the intermediate shaft 19. In the damper 12, a drive plate 12b and driven plates 12c, 12c are connected to each other via a coil spring 12a in a relatively rotatable manner by a predetermined amount, the drive plate 12b is spline-engaged with the intermediate shaft 19, and the cushion plate 11a of the clutch 11 is fixed to the driven plate 12c so as to extend radially outward of the driven plate 12c.

A release bearing b1 is disposed on an outer periphery of a bearing b2, which supports the intermediate shaft 19 with respect to the housing case 4A, so as to be axially movable by a predetermined amount, and the release bearing b1 abuts an inner diameter side base end of the diaphragm spring 15. A cylinder configured of an annular recessed portion which is coaxial with the first axis AX1 (intermediate shaft 19) is formed in the housing case 4A, a piston 18 is oil-tightly fitted to the cylinder, and thus, the hydraulic servo 16 is structured. The piston 18 and the release bearing b1 are connected to each other by a stepped plate 17, and the clutch 11 is operated to be connected/disconnected by expansion/contraction operation of the hydraulic servo 16. If the clutch 11 is connected, the engine output shaft 2 and the intermediate shaft 19 are drivingly connected via the damper 12.

On the speed change mechanism 30 side (a side opposite from the engine in the axial direction) of the intermediate shaft 19, an input shaft 31 of the speed change mechanism 30 described in details below is spline-engaged with the inner peripheral portion, and a large diameter gear 21 which is the connection mechanism 20 is formed on the outer peripheral portion. An end portion of the intermediate shaft 19 on the speed change mechanism 30 side is drivingly connected to a mechanical oil pump 80.

The connection mechanism 20 is structured to include the large diameter gear 21 formed on the above-described intermediate shaft 19, an idler gear 22 meshing with the large diameter gear 21, and a small diameter gear 23 which meshes with the idler gear 22 and is formed on a rotor shaft 45 described below. The large diameter gear 21 is positioned between the clutch device 10 and the speed change mechanism 30 (mechanical oil pump 80) in the axial direction and is formed in a flange shape which extends in the radial direction. In addition, the idler gear 22 is positioned on a third axis AX3 which is parallel to and different from the first axis AX1 and the second axis AX2, and is disposed so as to be rotatably supported on the housing case 4A and an oil pump cover 81 by ball bearings b3 and b4. Moreover, the small diameter gear 23 is formed on the outer periphery of the engine-side end portion of the rotor shaft 45 in the axial direction, which is rotatably disposed on the second axis AX2.

As described above, the connection mechanism 20 is disposed more toward the engine side in the axial direction than the speed change mechanism 30 and the motor 40 described in details below, and is disposed more toward the speed change mechanism 30 side than the above-described clutch device 10. That is, the connection mechanism is disposed between the clutch device 10 and the speed change mechanism 30 in the axial direction. In addition, the intermediate shaft 19 is drivingly connected to the input shaft 31 of the speed change mechanism 30 by spline-engagement, and the intermediate shaft 19 is drivingly connected to the rotor shaft 45 via the large diameter gear 21, the idler gear 22, and the small diameter gear 23. That is, the speed change mechanism 30 and the motor 40 are drivingly connected to each other by the connection mechanism 20.

In the connection mechanism 20, rotation from the motor 40 is decreased in speed based on sizes of the diameters of the small diameter gear 23 and the large diameter gear 21 and the gear ratio, and is transmitted to the input shaft 31 of the speed change mechanism 30. In addition, since the idler gear 22 is disposed more toward the engine side in the axial direction than a coil end 43a of the motor 40 and the speed change mechanism 30, the idler gear 22 does not interfere with the motor 40 or the speed change mechanism 30 and is not interposed between the speed change mechanism 30 and the motor 40, and thus, it is possible to dispose the speed change mechanism 30 and the motor 40 closer to each other in the radial direction.

The motor 40 includes a stator 41 which is fixed to the main case 4B, a rotor 42 which is integrally fixed to the rotor shaft 45 rotatably disposed on the inner peripheral side of the stator 41, and a coil winding 43 which is wound around the stator 41, and coil ends 43a, 43a which protrude to both ends in the axial direction from the stator 41 are formed. Moreover, the stator 41 is disposed to be fitted and fixed to the inner peripheral surface of a cylindrical portion 4Bb formed on the main case 4B.

Both end portions in the axial direction of the rotor shaft 45 are supported to the housing case 4A and the main case 4B via the ball bearings b5 and b6, respectively, so as to be rotatable with high accuracy. Moreover, preferably, the motor 40 is a brushless DC motor (IPM motor or SPM motor) in which a coil is embedded on the stator 41 side and a permanent magnet is embedded on the rotor 42 side. However, the motor 40 optionally includes other motors such as a reluctance motor. Moreover, a resolver 49, which is a rotation angle detection unit that detects a rotation angle of the rotor shaft 45, is disposed at the end portion on the opposite side of the rotor shaft 45 from the engine in the axial direction.

Meanwhile, the speed change mechanism 30 includes a planetary gear unit PU which is disposed on the first axis AX1, the planetary gear unit PU includes a sun gear S1, a sun gear S2, a carrier CR, and a ring gear R which are four rotational elements, and the planetary gear unit is configured of so-called Ravigneaux planetary gear in which a long pinion PL meshing with the sun gear S2 and the ring gear R, and a short pinion PS meshing with the sun gear S1 mesh with each other at the carrier CR.

The sun gear S2 of the planetary gear unit PU is connected to a brake B-1 (friction engagement element) and a brake B-2 (friction engagement element) via a one-way clutch F-1 so as to be fixable to the case 4, and is connected to a clutch C-3 (friction engagement element), and thus, the rotation from the input shaft 31 can be input to the sun gear S2 via the clutch C-3. Moreover, the sun gear S1 is connected to a clutch C-1 (friction engagement element), and thus, the rotation from the input shaft 31 can be input to the sun gear S1.

In addition, the carrier CR is connected to a clutch C-2 (friction engagement element) to which the rotation from the input shaft 31 is input, and thus, the rotation from the input shaft 31 can be input via the clutch C-2. Moreover, the carrier CR is connected to a one-way clutch F-2 and a brake B-3 (friction engagement element), the rotation in one direction with respect to the case 4 is regulated via the one-way clutch F-2, and the rotation can be freely fixed via the brake B-3.

In addition, the ring gear R is connected to the counter drive gear 39, and the counter drive gear 39 meshes with the counter driven gear 91 of the above-described counter shaft 90 (refer to FIG. 2). Moreover, the drive pinion 92 of the counter shaft 90 meshes with the differential ring gear 96 of the differential device 95, and is drivingly connected to left and right front wheels (not shown) via the differential device 95.

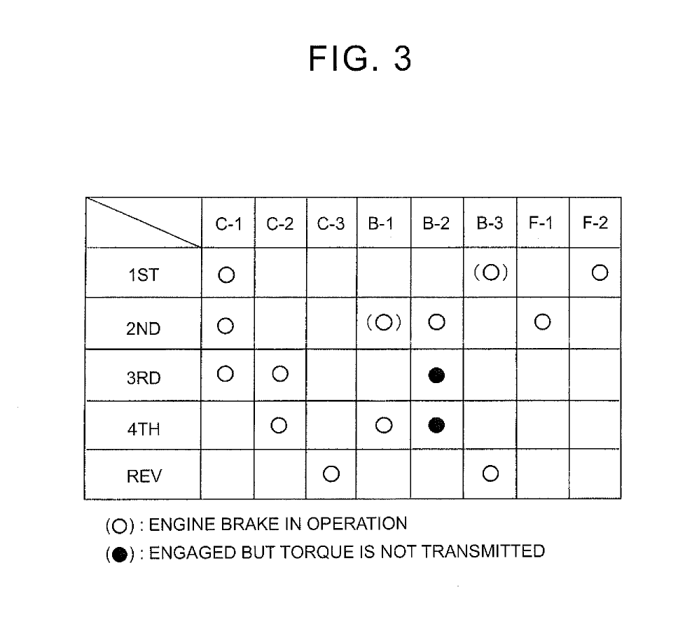

FIG. 3 is an operation table of the above-described automatic transmission 3, and the automatic transmission 3 engages and releases clutches and brakes (a plurality of friction engagement elements) according to combinations shown in the operation table so that first to fourth forward speeds and a first reverse speed (a plurality of shift speeds) are achieved.

In the speed change mechanism 30, on the engine side of the planetary gear unit PU in the axial direction, the clutch C-2 is disposed on the outer peripheral side of the input shaft 31, and the brake B-3 and the one-way clutch F-2 are disposed on the outer peripheral side of the planetary gear unit PU. Moreover, on the opposite side of the planetary gear unit PU from the engine in the axial direction, the one-way clutch F-1 is disposed on the outer peripheral side of the input shaft 31, and the brake B-2 is disposed on the outer peripheral side of the one-way clutch F-1. In addition, on the opposite side of the one-way clutch F-1 from the engine in the axial direction, the clutch C-1 and clutch C-3 are disposed in parallel on the outer peripheral side of the input shaft 31, and the brake B-1 is disposed on the outer peripheral side of the clutch C-1.

The brake B-1 includes friction plates 61 and a hydraulic servo 60 which presses and drives the friction plates 61. The friction plates 61 and the hydraulic servo 60 are disposed on the outer peripheral side of the clutch C-1 (refer to FIG. 3) having the friction plates and the hydraulic servo with large diameters because the clutch C-1 is engaged at a low speed and thus, has a large torque capacity. Therefore, the brake B-1 has the largest outer diameter among all the friction engagement elements (clutches C-1, C-2, and C-3, and brakes B-1, B-2, and B-3), that is, the brake B-1 is disposed at such a position as to protrude more radially outward than the brake B-2 or the brake B-3.

In the friction plates 61 of the brake B-1, outer friction plates are spline-engaged with an inlet portion of the opening portion 4Bc which is opened on the opposite side of the speed change mechanism 30 in the main case 4B from the engine, and inner friction plates are spline-engaged with a hub member connected to the sun gear S2.

The hydraulic servo 60 of the brake B-1 is structured to include a cylinder portion 63 which is formed on an inner surface of the rear cover 4C, a piston 62 which is disposed to face the cylinder portion 63 and is disposed to be movable in the axial direction with respect to the rear cover 4C, a spring 65 which biases the piston 62 to the cylinder portion 63 side, and a hydraulic oil chamber 64 which is formed between the cylinder portion 63 and the piston 62.

Moreover, a joint portion 4J, which is formed by joining a joint surface 4Ba of the main case 4B and a joint surface 4Ca of the rear cover 4C with bolts 50, is disposed on the outer peripheral side of the brake B-1 having the largest outer diameter. Since the joint portion 4J is fastened with a plurality of bolts 50 (refer to FIG. 2), the joint portion 4J has a thickness suitable for the bolts 50 on the inner and outer peripheral sides. The motor 40 is disposed such that a portion thereof, specifically, a portion of the stator 41, overlaps the joint portion 4J, that is, the outer peripheral portion of the rear cover 4C when viewed in the axial direction, as shown in FIG. 2.

As the automatic transmission 3 described above, in the automatic transmission (for example, refer to Japanese Patent Application Publication No. 10-169730 (JP 10-169730A)) which includes the speed change mechanism having the structure in which the friction engagement element (brake B-1) having the largest outer diameter is disposed at the end portion on the opposite side from the engine, a recess is formed between the housing case 4A which is positioned on the engine side of the automatic transmission and the end portion on the opposite side of the automatic transmission from the engine (that is, the rear cover 4C).

In the present hybrid drive apparatus 1, the motor 40 is disposed in the recessed portion, that is, the motor 40 is disposed such that a portion thereof (specifically, a portion of the stator 41) overlaps the rear cover 4C covering one side of the speed change mechanism 30 in the axial direction when viewed in the axial direction, thereby hybridizing the automatic transmission 3. Accordingly, the motor 40 can be disposed close to the speed change mechanism 30, and the hybrid drive apparatus 1 can be structured, which is downsized in the radial direction.

Moreover, since the connection mechanism 20, with which the speed change mechanism 30 and the motor 40 are drivingly connected, is disposed more toward the engine side in the axial direction than the speed change mechanism 30, that is, the connection mechanism 20 is disposed between the clutch device 10 and the speed change mechanism 30 in the axial direction, the motor 40 can be disposed so as to overlap the speed change mechanism 30 when viewed in the radial direction. Accordingly, compared to the case where the motor 40 is disposed between the clutch device 10 and the speed change mechanism 30 in the axial direction, an axial length of the hybrid drive apparatus 1 can be decreased, and downsizing of the hybrid drive apparatus 1 in the radial direction can be achieved.

The brake B-1 has the largest outer diameter. Thus, when the present hybrid drive apparatus 1 is manufactured, each component (at least the brake B-1) of the speed change mechanism 30 is assembled by insertion from the opening portion 4Bc of the main case 4B positioned on the opposite side from the engine in the axial direction, and the rear cover 4C is joined to the joint portion 4J with bolts 50, thus completing the assembly of the speed change mechanism 30. On the other hand, since the motor 40 overlaps a portion of the rear cover 4C when viewed in the axial direction, it is difficult to assemble the motor from the opposite side from the engine in the axial direction beyond the rear cover 4C.

Accordingly, the motor 40 is assembled by insertion from the engine side in the axial direction with respect to the main case 4B, and thereafter, the housing case 4A is joined to the main case 4B while the connection mechanism 20 is assembled. Then, the clutch device 10 is assembled to the housing case 4A by insertion from the engine side in the axial direction.

In this way, since the speed change mechanism 30 is assembled to the main case 4B from the opposite side from the engine in the axial direction, and the motor 40 is assembled to the main case 4B from the engine side in the axial direction, the motor 40 can be disposed such that a portion thereof overlaps the rear cover 4C when viewed in the axial direction. Accordingly, it is possible to dispose the motor 40 and the speed change mechanism 30 close to each other, and downsizing of the hybrid drive apparatus 1 in the radial direction can be achieved.

Note that, in the above-described embodiment, the speed change mechanism which uses the multi-stage transmission capable of achieving four forward speeds is described. However, as long as the speed change mechanism has such a shape that a recess is formed between the housing case and the rear cover, the present invention can be applied to any of a belt-type continuously variable speed change mechanism, a toroidal-type continuously variable speed change mechanism, a ring-corn type continuously variable speed change mechanism, or the like.

Particularly, the speed change mechanism 30 which uses a Ravigneaux-type planetary gear unit is described. However, a Simpson-type planetary gear unit may be used, that is, any type may be used as long as the planetary gear unit has a structure in which the diameter is more easily reduced compared to the friction engagement element having the largest outer diameter.

Moreover, in the present embodiment, the connection mechanism 20 is described in which the input shaft 31 of the speed change mechanism 30 and the rotor shaft 45 of the motor 40 are drivingly connected to each other with gear trains. However, for example, the connection mechanism may be drivingly connected with a chain, a belt, or the like.

In addition, in the present embodiment, the clutch device 10 in which the dry clutch 11 is engaged and disengaged by the hydraulic servo 16 is described. However, of course, a wet multi-plate clutch, a wet single-plate clutch, or the like may be used.

Moreover, the present embodiment in which the outermost diameter of the motor 40 is the outer diameter of the stator 41 is described. However, there is a case where the coil end is the outermost diameter of the motor when the coil windings are increased in order to improve the output of the motor. In this case, the motor is disposed such that only a portion of the coil end overlaps the rear cover when viewed in the axial direction, which also is within the application range of the present invention.

### INDUSTRIAL APPLICABILITY

A hybrid drive apparatus according to the present invention can be used in a vehicle such as a passenger car, truck, or the like, and particularly, is suitable to a vehicle which includes a rotary electric machine disposed on a second axis parallel to the first axis, on which a speed change mechanism is disposed, and in which downsizing in a radial direction is required.

### Description of the Reference Numerals

1: hybrid drive apparatus

2: engine output shaft

4B: case main body (main case)

4Bc: opening portion

4C: cover member (rear cover)

4J: joint portion

20: connection mechanism

30: speed change mechanism

40: rotary electric machine (motor)

41: stator

42: rotor

AX1: first axis

AX2: second axis

C-1, C-2, and C-3: friction engagement element (clutch)

B-1, B-2, and B-3: friction engagement element (brake)

1. A hybrid drive apparatus, which includes a speed change mechanism disposed on a first axis coaxial with an engine output shaft and a rotary electric machine disposed on a second axis parallel to the first axis, comprising:
a case main body which accommodates the speed change mechanism and the rotary electric machine and has an opening portion opening on one side of the speed change mechanism in an axial direction; and
a cover member which closes the opening portion of the case main body, wherein
the rotary electric machine is disposed such that a portion thereof overlaps the cover member when viewed in the axial direction.

2. The hybrid drive apparatus according to claim 1, wherein
the rotary electric machine includes a stator which is fixed to the case main body and a rotor which is rotatably disposed on an inner peripheral side of the stator, and
the stator is disposed such that a portion thereof overlaps the cover member when viewed in the axial direction.

3. The hybrid drive apparatus according to claim 1, wherein
a connection mechanism, with which the speed change mechanism and the rotary electric machine are drivingly connected, is provided on a side more toward an engine in the axial direction than the speed change mechanism, and
the rotary electric machine is disposed so as to overlap the speed change mechanism when viewed in a radial direction.

4. The hybrid drive apparatus according to claim 1, wherein
the speed change mechanism includes a plurality of friction engagement elements, and a plurality of shift speeds are achieved by engagement and disengagement of the friction engagement elements,
a friction engagement element having a largest outer diameter, among the plurality of friction engagement elements, is disposed at an end portion on a side of the speed change mechanism opposite from the engine in the axial direction, and
a joint portion which joins the case main body and the cover member is disposed on an outer peripheral side of the friction engagement element having the largest outer diameter.

5. The hybrid drive apparatus according to claim 1, wherein
at least a portion of the speed change mechanism is assembled to the case main body from a side opposite from the engine in the axial direction via the opening portion, and
the rotary electric machine is assembled to the case main body from the engine side in the axial direction.
